(19) United States
(12) Patent Application Publication
(10) Pub. No.: US 2015/0278914 A1
(43) Pub. Date: Oct. 1, 2015

(54) METHOD FOR RECOMMENDING SUPPLIERS

(71) Applicant: RICHPLAY INFORMATION CO., LTD., NEW TAIPEI CITY (TW)

(72) Inventors: WEN-REN HUANG, TAIPEI CITY (TW); YI-HSIANG CHEN, NEW TAIPEI CITY (TW)

(21) Appl. No.: 14/657,046

(22) Filed: Mar. 13, 2015

(30) Foreign Application Priority Data
Mar. 28, 2014 (TW) 103111617

(51) Int. Cl. G06Q 30/06; G06Q 30/02

(52) U.S. Cl. CPC G06Q 30/0631; G06Q 30/0242

(57) ABSTRACT

The present invention discloses a method for recommending suppliers, which mainly comprises steps of: a server recording at least a supplier and at least a product related to the supplier; at least a client logging in the server and defining that the product belongs to a set; the client transmitting a social operating instruction related to the set; the server transmitting at least a questionnaire related to the set to the client; the client transmitting a questionnaire result related to the questionnaire to the server; the server executing the social operating instruction; the server compiling statistics of the client willing to buy or understand the product according to the questionnaire result for sorting the product; and the server enabling a shopping page or an advertisement page of the supplier to be related to the product according to the order of the product.

### FIELD OF THE INVENTION

The present invention relates generally to a method for recommending suppliers, and particularly to providing shopping pages for products by investigating users' buying willingness on products using questionnaires and selecting the suppliers with products having more user's buying willingness as cooperation targets.

### BACKGROUND OF THE INVENTION

Since 1990's, the World Wide Web has grown to the current gigantic scale within only 20 years. As computer equipment and the Internet become popularized, a novel business method, the e-commerce, is developing prosperously. By on-line posting and buying products, buyers and sellers can conduct various business activities without face-to-face interaction, which reduces space and time limitations on transaction behaviors and thus facilitating economic processes.

The e-commerce market in Taiwan was started in 2005 and has grown rapidly. In 2011, the annual transaction has exceeded 43 billion NT dollars. This e-commerce wave provides a sufficient base for nurturing numerous novel Internet companies. Many shops or brands having physical channels also started to develop network marketing aggressively in the hope of generating new profit margins by means of network platforms.

Presently, consumers have been used to the purchasing model of buying products from network platforms. Orders can be placed on the websites provided by the suppliers or third parties. Then the mechanisms of on-line payment and product delivery are followed. Consumers can complete the steps of browsing and buying products, payment, and product acquirement without leaving home and hence simplifying the purchasing process. Accordingly, by stimulating consumers' purchasing desire imperceptibly and raising their buying willingness, massive business opportunities can be created.

At present, the third-party vendors who provide suppliers with network platforms for selling products mostly wait for suppliers passively to seek cooperation; they lack active mechanism for developing suppliers. In addition, they also lack an effective mechanism for filtering supplier requesting cooperation. Thereby, instead of concentrating on the suppliers with better performance in sale, the marketing energy of network platforms is dispersed by the suppliers not interested by customers. Accordingly, the present invention develops a method for recommending suppliers. In the method, social services are integrated so that consumers can discuss, track, or share products. Besides, as consumers are using social services, the buying willingness or willingness of acquiring more information on related products is investigated using questionnaires. Hence, the feasible suppliers can be selected according to the buying willingness expressed by consumers. By using the consumer list with consumers having buying willingness, suppliers can be attracted for cooperation. Meanwhile, the webpages of buyable products are provided to consumers for matching suppliers and consumers.

### SUMMARY

An objective of the present invention is to provide a method for recommending suppliers. When clients want to discuss and share products, questionnaires are used for investigating their buying willingness or willingness of acquiring more information on the products and like ones. Thereby, the suppliers providing products with more clients' buying willingness can be selected as targets for cooperation. Then the products can be provided for purchasing or advertisement pages can be provided.

Another objective of the present invention is to provide a method for recommending suppliers. When clients want to discuss and share products, questionnaires are used for investigating their buying willingness on the products and like ones. Thereby, the shopping pages of products can match the clients with buying willingness.

Still another objective of the present invention is to provide a method for recommending suppliers. When clients want to discuss and share products, questionnaires are used for investigating their willingness of acquiring more information on the products and like ones. Thereby, the advertisement pages of products can match the clients with willingness of acquiring more information.

In order to achieve the objectives and efficacies as described above, the present invention discloses a method for recommending suppliers, which mainly comprises steps of: a server recording at least a supplier and at least a product related to the supplier; at least a client logging in the server and defining that the product belongs to a set; the client transmitting a social operating instruction related to the set; the server transmitting at least a questionnaire related to the set to the client; the client transmitting a questionnaire result related to the questionnaire to the server; the server executing the social operating instruction; the server compiling statistics of the client willing to buy or understand the product according to the questionnaire result for sorting the product; and the server enabling a shopping page or an advertisement page of the supplier to be related to the product according to the order of the product.

After the step of the server enabling a shopping page or an advertisement page of the supplier to be related to the product according to the order of the product, the present invention further comprises a step of the server transmitting the client's client information to the supplier and the shopping page or the advertisement page to the client if the questionnaire result shows that the client is willing to buy or understand the product.

After the step of the server transmitting the client's client information to the supplier and the shopping page or the advertisement page to the client, the present invention further comprises steps of the client buying the product via the shopping page or the client browsing the advertisement page; and the server compiling statistics of the client buying the product via the shopping page or the client browsing the advertisement page, and transmitting the statistics result of the client buying the product via the shopping page or the client browsing the advertisement page or the client information to the supplier.

### BRIEF DESCRIPTION OF THE DRAWINGS

FIG. 1A shows a schematic diagram of component relationship according a preferred embodiment of the present invention;

FIG. 1B shows a flowchart (1) according a preferred embodiment of the present invention;

FIG. 1C shows a flowchart (2) according a preferred embodiment of the present invention; and

FIG. 1D shows a flowchart (3) according a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a method for recommending suppliers, which is characterized in that when a client performs social operations on some products, the client's willingness of buying or understanding the products and the like can be investigated using questionnaires for selecting the suppliers with products having more client's buying willingness as cooperation targets. The cooperation targets are asked to provide shopping or advisement pages of the products. Thereby, the shopping or advertisement pages of products can match the clients with willingness of buying or getting more information.

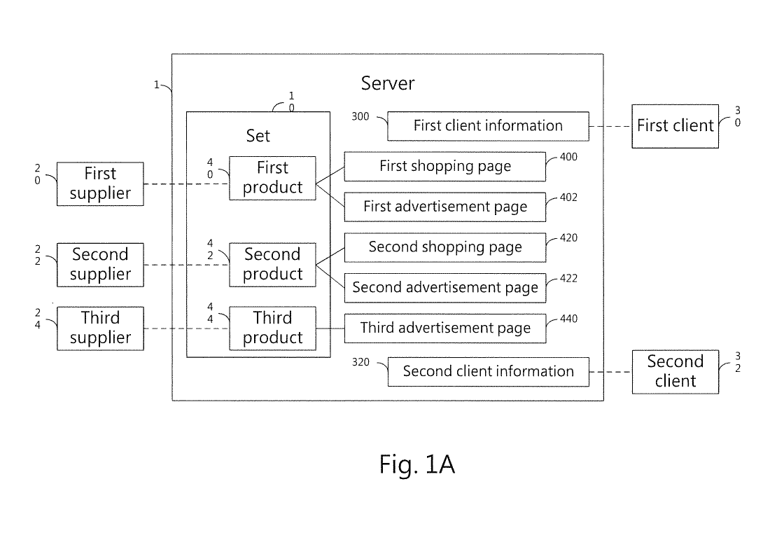

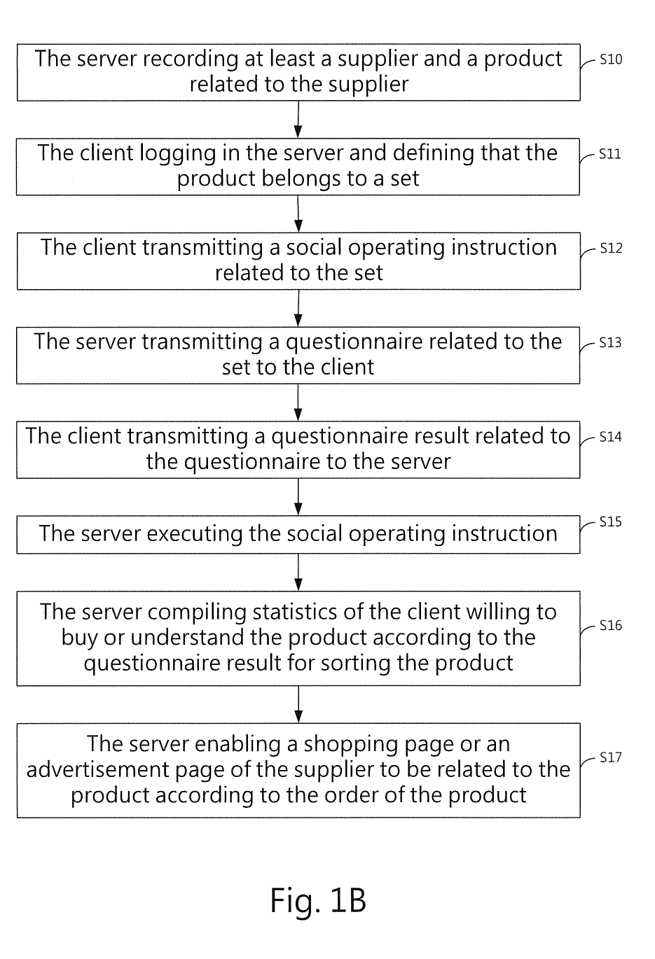

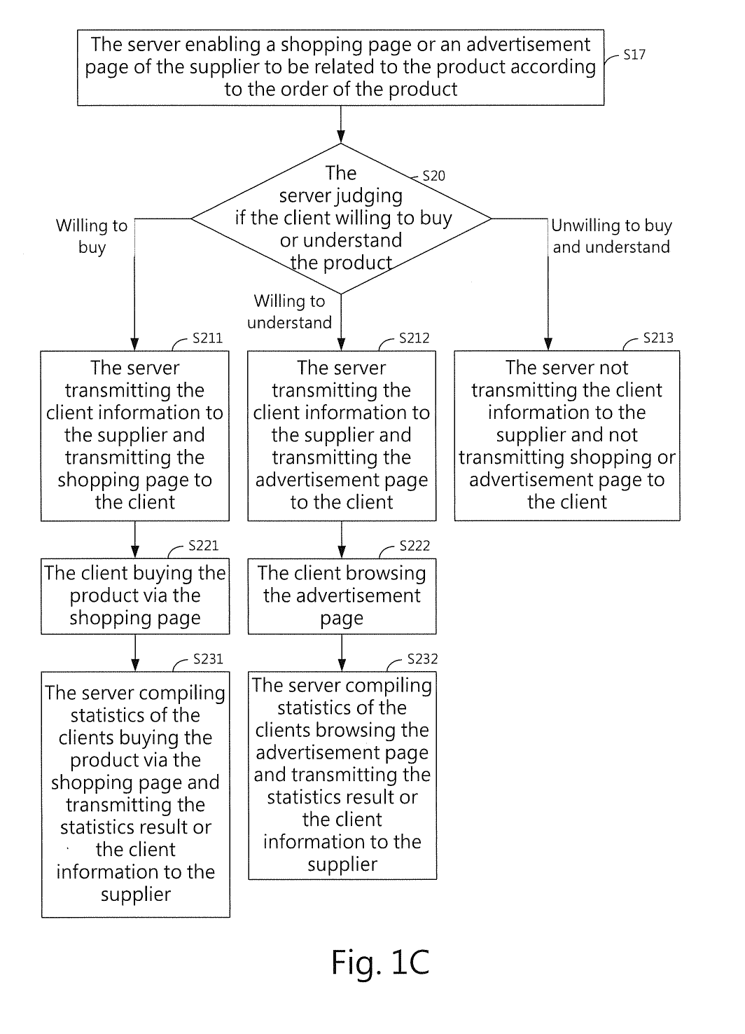

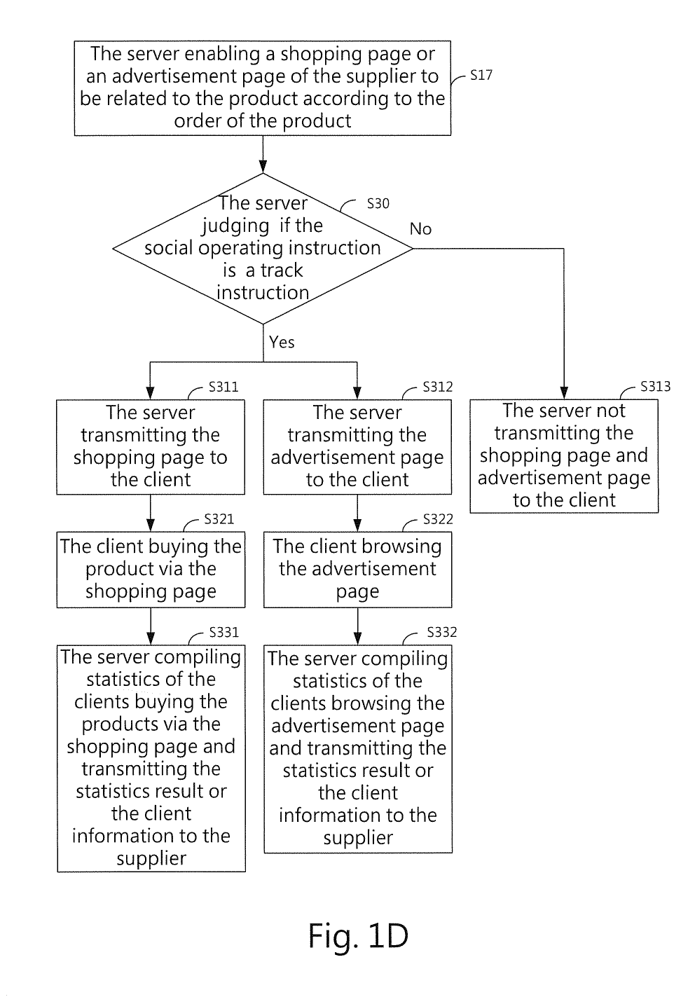

First, please refer to FIGS. 1A and 1B, which show a schematic diagram of component relationship and a flowchart (1) according a preferred embodiment of the present invention. As shown in FIG. 1A, the components according to the present embodiment comprises a server 1, a first supplier 20, a first product 40 provided by the first supplier 20, a second supplier 22, a second product 42 provided by the first supplier 22, a third supplier 24, a third product 44 provided by the first supplier 24, a first client 30, and a second client 32.

As shown in FIG. 1B, the method for recommending suppliers according to the present invention comprises at least the following steps:
Step S10: The server recording at least a supplier and a product related to the supplier;
Step S11: The client logging in the server and defining that the product belongs to a set;
Step S12: The client transmitting a social operating instruction related to the set;
Step S13: The server transmitting a questionnaire related to the set to the client;
Step S14: The client transmitting a questionnaire result related to the questionnaire to the server;
Step S15: The server executing the social operating instruction;
Step S16: The server compiling statistics of the client willing to buy or understand the product according to the questionnaire result for sorting the product; and
Step S17: The server enabling a shopping page or an advertisement page of the supplier to be related to the product according to the order of the product.

In the step S10, the server 1 records that the first product 40 is related to the first supplier 20, the second product 42 is related to the second supplier 22, and the third product 44 is related to the third supplier 24.

One purpose of the method for recommending suppliers according to the present invention is to select preferential suppliers for cooperation from a plurality of suppliers. The third party who provides the network platform can gather spontaneously the lists of products in various fields and their suppliers. In the step S10, the correlation between the products and the suppliers are recorded in the server 1. Then the subsequent questionnaire result can be used for selecting the suppliers providing the products having more clients with buying willingness as the preferential targets for cooperation.

In the step S11, the first client 30 logs in the server 1 and defines that the first product 40 and the second product 42 belong to a set 10; the second client 32 logs in the server 1 and defines that the first product 40 and the third product 44 belong to the set 10.

In the method for recommending suppliers according to the present invention, a plurality of clients define the correlation among products voluntarily via the step S11. The server 1 can compare the products defined in the same set by the clients. The correlation among products can be calculated according to the frequency they are defined in the same set. In the subsequent questionnaire investigation, the products defined correlated by the clients can be investigated at the same time.

In the step S12, the first client 30 transmits a first social operating instruction, which is a submit message instruction, related to the first product 40 of the set 10 for submitting a message about the first product 40; the second client 32 transmits a second social operating instruction, which is a track instruction, related to the third product 44 of the set 10 for tracking the related news of the third product 44.

In the method for recommending suppliers according to the present invention, the clients can use various social operating instructions, for example, the submit message instruction, the reply message instruction, track instruction, or share instruction, for performing social operations on the sets or the products belonging to the sets. Then the clients can submit or reply messages for a specific set or product, or track or share a specific set or product. In the step S12, the social operation can trigger subsequent a questionnaire investigation. In order to make the clients finish the questionnaire, social operating instructions will not be executed before the questionnaire investigation is completed.

In the step S13, the server 1 transmits a first questionnaire about the first product 40, the second product 42, and the third product 44 related to the set 10 to the first client 30 and a second questionnaire about the first product 40, the second product 42, and the third product 44 related to the set 10 to the second client 32.

In the method for recommending suppliers according to the present invention, the first priority is to investigate the client's willingness of buying or understanding the product on which he performs social operations. Alternatively, in the step S13, the client's willingness of buying or understanding any other product belonging to the set of the product can be investigated at the same time.

In the step S14, the first client 30 transmits a first questionnaire result related to the first questionnaire to the server 1 for replying the first questionnaire. The first questionnaire result shows that the first client 30 has buying willingness on the first and second products 40, 42 but has no buying or understanding willingness on the third product 44. The second client 32 transmits a second questionnaire result related to the second questionnaire to the server 1 for replying the second questionnaire. The second questionnaire result shows that the second client 32 has buying willingness on the first product 40 and understanding willingness on the second and third products 42, 44.

In the method for recommending suppliers according to the present invention. the step S14 is used to investigate the buying or understanding willingness on the sets or products included in the questionnaire. The options should comprises at least “have buying willingness”, “have understanding willingness”, and “no buying willingness”.

In the step S15, the server 1 executes the first social operating instruction of the first product 40 related to the set 10 and transmitted in the step S12 by the first client 30, and the first client 30 thus submitting message for the first product 40. In addition, the server 1 executes the second social operating instruction of the third product 44 related to the set 10 and transmitted in the step S12 by the second client 32, and the second client 32 thus sets to track the related news of the third product 44.

In the method for recommending suppliers according to the present invention, after the server 1 receives the client's questionnaire result, the step S15 can be used to execute the social operation performed originally by the client on the product in the step S12. These two steps can combine questionnaire investigation and social operation. Thereby, when the client uses the social functions provided by the network platform of the third party, the client's buying or understanding willingness on various products can be collected for the third party. Hence, the preferential suppliers can be selected for cooperation.

In the steps S16, the server 1 compiles statistics of the clients having buying or understanding willingness on the products according the first and second questionnaire results for sorting the products. According to the statistics, the first and second clients 30, 32 express buying willingness on the first product 40; the first client 30 expresses buying willingness on the second product 42; the second client 32 expresses understanding willingness on the third product 44. The server 1 sorts the products according to the number of clients having buying willingness and gives the order of the first, second, and third products 40, 42, 44.

In the method for recommending suppliers according to the present invention, the step S16 is used to sort the products according to the number of clients willing to buy or understand. By sorting the products according to the number of clients willing to buy or understand, more clients expressing buying or understanding willingness mean that the suppliers are more likely to agree to cooperate with the third party on providing the service.

In the step S17, according to the order of the first, second, and third products 40, 42, 44, the server 1 first negotiates with the first supplier 20 for the cooperation of selling the product. If the first supplier 20 agrees to cooperate, then a first shopping page 400 of the first product 40 (and a first advertisement page 402 of the first product 40) is related to the first product 40. Next, the server 1 negotiates with the second supplier 22 for the cooperation of selling the product. If the second supplier 22 agrees to cooperate, then a second shopping page 420 of the second product 42 is related to the second product 42. Besides, because the second client 32 expressed understanding willingness on the third product 44, the server 1 can negotiate with the third supplier 24 for the cooperation of advertising the product. If the third supplier 24 agrees to cooperate, then a third advertisement page 440 of the third product 44 is related to the third product 44.

In the method for recommending suppliers according to the present invention, the step S16 is used to sort the products according to the number of clients willing to buy or understand. Then the suppliers providing products having more clients expressing buying or understanding willingness are recommended as the preferential target for selling or advertisement cooperation. Moreover, in the step S17, the shopping or advertisement pages of the cooperating suppliers are related to the products. Thereby, clients can buy the products or read the advertisement information from the network platform provided by the third party.

By disposing the above components and executing the steps S10 to S17, the method for recommending suppliers according to the present invention can use questionnaires to investigate and collect clients' buying or understanding willingness on the products or related ones when the clients discuss or share product information using the social operating functions provided by the third party. Thereby, the preferential suppliers providing products with more clients willing to buy or understand can be recommended to the third party and thus ensuring the profits of the third party by matching the clients and the suppliers.

Please refer to FIG. 1A and FIG. 1C. FIG. 1C shows a flowchart (2) according a preferred embodiment of the present invention. As shown in FIG. 1C, after the step S17 in the method for recommending supplier according to the present invention, the following steps can be further included:
Step S20: The server judging if the client willing to buy or understand the product;
Step S211: The server transmitting the client information to the supplier and transmitting the shopping page to the client;
Step S221: The client buying the product via the shopping page;
Step S231: The server compiling statistics of the clients buying the product via the shopping page and transmitting the statistics result or the client information to the supplier;
Step S212: The server transmitting the client information to the supplier and transmitting the advertisement page to the client;
Step S222: The client browsing the advertisement page;
Step S232: The server compiling statistics of the clients browsing the advertisement page and transmitting the statistics result or the client information to the supplier; and
Step S213: The server not transmitting the client information to the supplier and not transmitting shopping or advertisement page to the client.

In the step S20, the server 1 judges if the first and second clients 30, 32 are willing to buy or understand the first, second, and third products 40, 42, 44, respectively, according to the first and second questionnaire results. As described above, the first client 30 expresses buying willingness on the first and second products 40, 42 and unwillingness on the third product 44 via the first questionnaire result; the second client 30 expresses buying willingness on the first products 40 and understanding willingness on the second and third products 42, 44 via the second questionnaire result.

If the server 1 judges that a specific client is willing to buy a specific product, for example, the first client 30 is willing to buy the first and second products 40, 42, the step S211 is executed, in which the server 1 transmits the first client information 300 of the first diem 30 and the second client information 320 of the second client 32 to the first supplier 20, and the first shopping page 400 to the first and second clients 30, 32 for buying the first product 40. Besides, the server 1 transmits the first client information 300 of the first client 30 to the second supplier 22, and the second shopping page 420 to the first client 30 for buying the second product 42.

In the method for recommending suppliers according to the present invention, the step S211 is used to match the client willing to buy a specific product and the supplier providing the specific product. The third party owns the information of the clients willing to buy products, which can be used as the incentive for the suppliers to cooperate with the third supplier for selling products. The clients' feedback on buying products can be acquired from the shopping page of the products after the suppliers cooperate with the third party and thus connecting the demands of the sellers and buyers.

After the step S211, the steps S221 to S231 can be executed. After the first and second clients 30, 32 buy the first product 40 via the first shopping page 400, the server 1 compiles statistics of the clients buying the first product 40 via the first shopping page 400 and transmits the statistics result or the first client information 300 of the first client 30 and the second client information 320 of the second client 32 to the first supplier 20. In addition, after the first client 30 buys the second product 42 via the second shopping page 420, the server 1 compiles statistics of the clients buying the second product 42 via the second shopping page 420 and transmits the statistics result or the first client information 300 of the first client 30 to the second supplier 22.

In the method for recommending suppliers according to the present invention, the steps S221 to S231 are used to compile statistics of the clients buying specific products and transmit the statistics result or client information to the suppliers of the products. Then the suppliers can manage payment and shipment. Besides, the statistics result of the clients buying specific products can be used in suppliers' sales management or as promotion data.

If the server 1 judges that a specific client is willing to understand a specific product, for example, the second client 32 is willing to understand the second and third products 42, 44, then the step S212 is executed, in which the server 1 transmits the second client information 320 of the second client 32 to the second and third suppliers 22, 24 and the second and third advertisement pages 422, 440 to the second client 32.

In the method for recommending suppliers according to the present invention, the step S212 is used to match the client willing to understand a specific product and the supplier of the specific product. The third party owns the information of the clients willing to understand products, which can be used as the incentive for the suppliers to cooperate with the third supplier for selling or promoting their products. The clients' feedback on buying products can be acquired from the advertisement page of the products after the suppliers cooperate with the third party and thus connecting the demands of both sides.

After the step S212, the steps S222 to S232 can be executed. The second client 32 can browse the second or third advertisement page 422, 440 for acquiring advertisement information of the second or third product 42, 44. Afterwards, the server 1 can compile statistics of the clients browsing the second or third advertisement pages 422, 440 and transmit the statistics result or the second client information 320 of the second client 32 to the second or third supplier 22, 24.

In the method for recommending suppliers according to the present invention, the steps S222 to 9232 are used to compile statistics of the clients reading the advertisement information of specific products and transmit the statistics result or the client information to the suppliers of the products. Then the statistics result or the client information can be used in suppliers' sales management or as promotion data.

If the server 1 judges that a specific client is unwilling to buy a specific product, for example, the first client 30 is unwilling to buy the third product 44, the step S213 is executed, in which the server 1 does not transmit the first client information 300 of the first client 30 to the third supplier 24 of the third product 44. In addition, the server 1 does not transmit the third advertisement page 4440 of the third product 44 to the first client 30, either.

By disposing the above components and executing the steps S20 to S231 or S232 or S213, the method for recommending suppliers according to the present invention can match buying service of products and the clients willing to buy or match the advertisements of products and the clients willing to understand. Then the suppliers of the products can acquire the statistics result or client information of the clients willing to buy or understand, and the clients willing to buy or understand the products can access the shopping or advertisement pages of the products for buying the products or reading the advertisement information.

Please refer to FIG. 1A and FIG. 1D. FIG. 1D shows a flowchart (3) according a preferred embodiment of the present invention. As shown in FIG. 1D, after the step S17 in the method for recommending supplier according to the present invention, the following steps can be further included:
Step S30: The server judging if the social operating instruction is a track instruction;
Step S311: The server transmitting the shopping page to the client;
Step S321: The client buying the product via the shopping page;
Step S331: The server compiling statistics of the clients buying the products via the shopping page and transmitting the statistics result or the client information to the supplier;
Step S312: The server transmitting the advertisement page to the client;
Step S322: The client browsing the advertisement page;
Step S332: The server compiling statistics of the clients browsing the advertisement page and transmitting the statistics result or the client information to the supplier; and
Step S313: The server not transmitting the shopping page and advertisement page to the client.

In the step S30, the server 1 judges if the first social operating instruction related to the first product 40 and transmitted by the first client 30 and the second social operating instruction related to the third product 44 and transmitted by the second client 32 in the step S12 are track instructions, respectively.

If the server 1 judges that a specific social operating instruction is a track instruction, for example, the second social operating instruction related to the third product 44 and transmitted by the second client 32 being a track instruction, the step S311 or S312 is then executed, in which the server 1 transmits the third advertisement page 440 or a third shopping page (not shown in the figure) related to the third product 44 to the second client 32. Thereby, the second client 32 can acquire the advertisement information of the third product 44 or buy the third product 44.

In the method for recommending suppliers according to the present invention, the step S311 is used to make the client tracking a specific product access the shopping or advertisement page of the product. Thereby, the client can buy the specific product or read the advertisement message of the specific product.

After the step S311, the steps S321 to S331 can be executed. After the second client 32 buys the third product 44 via the third shopping page, the server 1 can compile statistics of the clients buying the third product 44 via the third shopping page and transmit the statistics result or the second client information 320 of the second client 32 to the third supplier 24.

In the method for recommending suppliers according to the present invention, the steps S321 to S331 are used to compile statistics of the clients buying specific products and transmit the statistics result or client information to the suppliers of the products. Then the suppliers can manage payment and shipment. Besides, the statistics result of the clients buying specific products can be used in suppliers' sales management or as promotion data.

After the step S312, the steps S322 to S332 can be executed, in which the second client 32 can browse the third advertisement page 440 for acquiring the advertisement information of the third product 44. Afterwards, the sever 1 can compile statistics of the clients browsing the third advertisement page 440 and transmit the statistics result or the second client information 320 of the second client to the third supplier 24.

In the method for recommending suppliers according to the present invention, the steps S322 to S332 are used to compile statistics of the clients reading the advertisement information of specific products and transmit the statistics result or the client information to the suppliers of the products. Then the statistics result or the client information can be used in suppliers' sales management or as promotion data.

If the server 1 judges that the specific social operating instruction is not a track instruction, for example, the first social operating instruction related to the first product 40 and transmitted by the first client 30 being a submit message instruction instead of a track instruction, the step S313 is executed, in which the server 1 does not transmit the third advertisement page 440 of the third product 44 to the first client 30.

By disposing the above components and executing the steps S30 to S331 or S332 or S313, the method for recommending suppliers according to the present invention can make the client tracking a specific product acquire the shopping or advertisement page of the product for buying the product or reading the advertisement information of the product.

To sum up, the method for recommending suppliers according to the present invention can use the pop-up questionnaire appeared when a client performs social operations on a specific product to investigate the buying or understanding willingness on the specific product or related ones. Thereby, the preferential suppliers can be determined according to the products having more clients with buying or understanding willingness. Besides, the suppliers and the clients with buying or understanding willingness can be matched.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for recommending suppliers, comprising steps of:
a server recording at least a supplier and at least a product related to said supplier;
at least a client logging in said server and defining that said product belongs to a set;
said client transmitting a social operating instruction related to said set;
said server transmitting at least a questionnaire related to said set to said client;
said client transmitting a questionnaire result related to said questionnaire to said server;
said server executing said social operating instruction;
said server compiling statistics of said client willing to buy or understand said product according to said questionnaire result for sorting said product; and
said server enabling a shopping page or an advertisement page of said supplier to be related to said product according to the order of said product.

2. The method for recommending supplier of claim 1, and after said step of said server enabling said shopping page or said advertisement page of said supplier to be related to said product according to the order of said product, further comprising a step of said server transmitting said client's client information to said supplier and said shopping page or said advertisement page to said client if said questionnaire result shows that said client is willing to buy or understand said product.

3. The method for recommending supplier of claim 2, and after said step of said server transmitting said client's client information to said supplier and said advertisement page to said client, further comprising steps of:
said client browsing said advertisement page; and
said server compiling statistics of said client browsing said advertisement page and transmitting said statistics result of said client browsing said advertisement page or said client information to said supplier.

4. The method for recommending supplier of claim 1, and after said step of said server enabling said shopping page or said advertisement page of said supplier to be related to said product according to the order of said product, further comprising a step of said server transmitting client's client information to said supplier and transmitting said shopping page to said client if said questionnaire result shows that said client is willing to buy said product.

5. The method for recommending supplier of claim 4, and after said step of said server transmitting said client's client information to said supplier and said shopping page to said client, further comprising steps of:
said client buying said product via said advertisement page; and
said server compiling statistics of said client buying said product via said shopping page and transmitting said statistics result of said client buying said product via said shopping page or said client information to said supplier.

6. The method for recommending supplier of claim 1, wherein said social operating instruction is a submit message instruction, a reply message instruction, a track instruction, or a share instruction.

7. The method for recommending supplier of claim 6, and after said step of said server enabling said shopping page or said advertisement page of said supplier to be related to said product according to the order of said product, further comprising a step of said serve transmitting client's client information to said supplier if said social operating instruction is a track instruction.

8. The method for recommending supplier of claim 6, and after said step of said server enabling said shopping page or said advertisement page of said supplier to be related to said product according to the order of said product, further comprising a step of said serve transmitting said shopping page or said advertisement page to said client if said social operating instruction is a track instruction.

9. The method for recommending supplier of claim 8, and after said step of said serve transmitting said shopping page or said advertisement page to said client, further comprising steps of:
said client browsing said advertisement page; and
said server compiling statistics of said client browsing said advertisement page and transmitting said statistics result of said client browsing said advertisement page or said client information to said supplier.

10. The method for recommending supplier of claim 8, and after said step of said serve transmitting said shopping page or said advertisement page to said client, further comprising steps of:
said client buying said product via said advertisement page; and
said server compiling statistics of said client buying said product via said shopping page and transmitting said statistics result of said client buying said product via said shopping page or said client information to said supplier.
